(19) United States
(12) Patent Application Publication
(10) Pub. No.: US 2014/0049051 A1
(43) Pub. Date: Feb. 20, 2014

(54) Counterweight Electrical Generating System

(71) Applicant: Shannon Burke, Tofield (CA)

(72) Inventor: Shannon Burke, Tofield (CA)

(21) Appl. No.: 13/964,480

(22) Filed: Aug. 12, 2013

Related U.S. Application Data
(60) Provisional application No. 61/684,183, filed on Aug. 17, 2012.

(51) Int. Cl. F03G 7/08; H02K 35/02

(52) U.S. Cl. CPC F03G 7/08; H02K 35/02
USPC 290/1 R

(57) ABSTRACT

An energy generator device is disclosed that creates self-sufficient electricity without the need for external resources. The device comprises two vertical members, each comprising a weight. The weights of the vertical members are secured to a chain which is passed over a sprocket. The sprockets are then rigidly attached to an axle, such that passing the chain over the sprockets rotates the axles. The axles are secured to a gearbox, which is then secured to a magnetic induction generation component. The weights move opposite of each other, such that when one weight is raised the other is lowered, with the lowering weight activating a switch that turns on a hydraulic pump and piston, which then acts to raise the weight. The raising and lowering of the weights rotates the axles, which in turn rotates the turbines of the magnetic induction generation components to produce electricity.

### CROSS-REFERENCE

This application claims priority from Provisional Patent Application Ser. No. 61/684,183 filed Aug. 17, 2012.

### BACKGROUND

In a modern society, everyone consumes energy to make their daily lives easier. However, current methods used to harness this energy can do harm to people and to the planet. For example, burning fuels can be hazardous to the environment and to the overall health of people and animals. Furthermore, fossil fuels can also be extremely costly. An effective solution is necessary.

The present invention makes each residence a self-sufficient unit The device eliminates the need for burning fuels as well as the need for overhead and/or underground power lines. The energy generator device comprises two separate frame units that work together as one to produce energy. With an initial charge to power the hydraulics in the first unit to raise the weight system, kinetic energy is then produced once the electronically controlled bleeder valve is opened and the weight descend begins. Thus, by utilizing this kinetic energy to produce electricity, a portion of the electricity generated can produce a large amount of mechanical energy with the help of the hydraulics raising the weight system in the second unit. Everyone from individual homeowners to major players in the energy industry may appreciate the convenience and efficiency afforded by this device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an energy generator device that creates self-sufficient electricity without the need for external resources. The energy generator device comprises a first and second vertical member, each comprising at least one weight, wherein the weights move opposite of each other; and a magnetic induction generation component in communication with the weights, such that the raising or lowering of the weights causes the turbine of the magnetic induction generation component to rotate and produce electricity.

Furthermore, the weights of the first and the second vertical members are each secured to a chain which is passed over a sprocket. The sprockets are then rigidly attached to an axle, such that passing the chain over the sprockets rotates the axles. The axles are each secured to a gearbox, which is then secured to a magnetic induction generation component. The magnetic induction generation component comprises a turbine which includes a plurality of magnets in rotational orientation (or alignment). When the turbine rotates, the magnets rotate past each other to create an electrical charge. Thus, rotation of the axles rotates the turbines of the magnetic induction generation components to produce electricity. Further, the gearbox acts to control the rate of spin (or rotation) of the turbine of the magnetic induction generation component, which alters the amount of electricity produced by the turbine

Additionally, the energy generator device comprises a fluid motion device, such as a pump and valve assembly or a hydraulic pump and piston which acts to raise the weights. Specifically, a hydraulic pump and piston is secured to both the first and second vertical members and controls the raising of the weights. Further, the hydraulic pump and piston comprises a switch which turns on the pump and activates the hydraulic piston when the weights are proximate to a lower limit (or at a predetermined distance from the lower limit). Specifically, the hydraulic pump and piston act to raise the weights to an upper limit. Once the weights reach the upper limit, they are allowed to free fall down to a lower limit. The weights move opposite of each other, such that when one weight is raised the other is lowered, etc., with the lowering weight activating a switch that turns on the hydraulic pump and piston, which then acts to raise the weight. The raising and/or lowering of the weights rotates the axles, which in turn rotates the turbines of the magnetic induction generation components to produce electricity.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the energy generator device in accordance with the disclosed architecture.

FIG. 2 illustrates a rear perspective view of the energy generator device in accordance with the disclosed architecture.

FIG. 3 illustrates a top perspective view of the energy generator device in accordance with the disclosed architecture.

FIG. 4 illustrates a perspective view of the weights, chains, and sprockets (in use) of the energy generator device in accordance with the disclosed architecture.

FIG. 5 illustrates a perspective view of the energy generator device in motion (use) in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention creates self-sufficient electricity without the need for external resources, and thus makes each residence a self-sufficient unit. The energy generator device eliminates the need for burning fuels as well as the need for overhead and/or underground power lines. The energy generator device comprises two separate vertical frame units that work together as one to produce energy. Initially, the external power needed to lift the weight in the first unit will be electrical to power the pump. However, once kinetic energy is achieved from the unit via one weight descending to turn the generator, a fraction of the electricity during the descend is then used to power the pump in unit two. Thus, the whole system will work like a ‘sea-saw’. Everyone from individual homeowners to major players in the energy industry may appreciate the convenience and efficiency afforded by this device.

The disclosed energy generator device comprises two vertical members, each comprising at least one weight. The weights of the vertical members are secured to a chain which is passed over a sprocket. The sprockets are then rigidly attached to an axle, with a separate axle needed for each unit, such that passing the chain over the sprockets rotates the axles. The axles are secured to a gearbox, which is then secured to a magnetic induction generation component. The weights move opposite of each other, such that when one weight is raised the other is lowered, with the lowering weight activating a switch that turns on a hydraulic pump and piston, which then acts to raise the weight. The raising and lowering of the weights rotates the axles, which in turn rotates the turbines of the magnetic induction generation components to produce electricity.

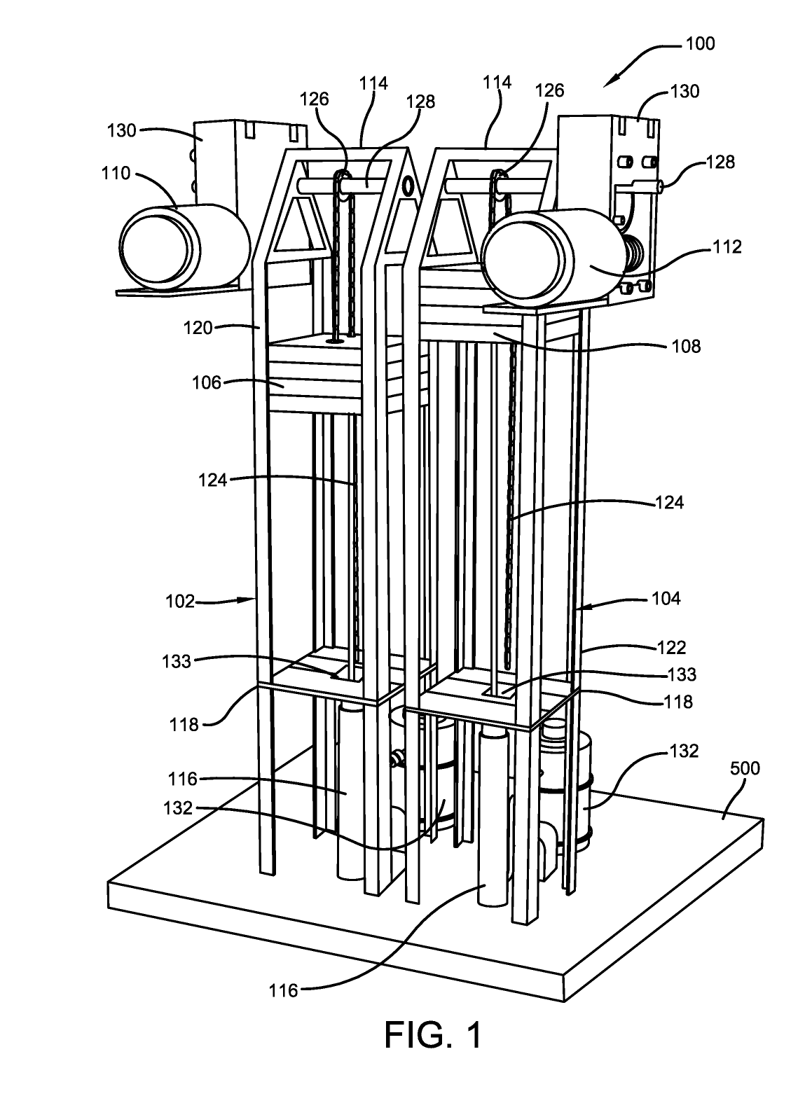

Referring initially to the drawings, FIGS. 1-4 illustrate the energy generator device 100 that creates self-sufficient electricity without the need for external resources. The energy generator device 100 comprises a first 102 and a second 104 vertical member, each comprising at least one weight (106, 108), wherein the weights move opposite of each other; and a magnetic induction generation component (110, 112) in communication with the weights (106, 108), such that the raising or lowering of the weights (106, 108) causes the magnetic induction generation component (110, 112) to rotate and produce electricity (as shown in FIG. 1).

The first 102 and second 104 vertical members each comprise a first end portion 114, and a second end portion 116, and opposing corners 118. Typically, the vertical members 102 and 104 are a rectangular prism, but the members 102, 104 can be any suitable shape as is known in the art without affecting the overall concept of the invention. The vertical members 102, 104 would generally be constructed of metal, such as aluminum, steel, etc., though any other suitable material may be used to manufacture the vertical members 102, 104 as is known in the art without affecting the overall concept of the invention.

The vertical members 102, 104 can also comprise a variety of colors and designs to suit user and manufacturing preference. While the shape and size of the vertical members 102, 104 may vary greatly depending on the wants and needs of a user, the vertical members 102, 104 are approximately between 96 and 144 inches long as measured from the first end portion 114 to the second end portion 116, and approximately between 48 and 72 inches wide as measured from opposing corners 118, and approximately between 36 and 60 inches thick as measured from a front surface 120 to a back surface 122. Considering the weight system, a typical energy generator device 100 for residential use will be approximately between 6-8 feet high, 6-8 feet wide, and 2-3 feet in depth (total). Additionally, any means of stabilizing the vertical members 102, 104 can be used. For example, by elongating the vertical members 102, 104 past the base plate to reach the ground, and then adding another oversized steel plate under the piston/pump/hydraulic tank assemblies, then welding the unit together as a whole provides support for the device 100.

Furthermore, the first vertical member 102 comprises at least one weight 106, and the second vertical member 104 comprises at least one weight 108. However, any suitable number of weights or a weight stack can be used depending on the wants and/or needs of a user. Further, the weights 106, 108 can be any suitable size, weight, and/or shape as is known in the art without affecting the overall concept of the invention, and realistically, consumer demand will directly impact the final dimensions of the energy generator device 100. Further, the weights 106, 108 can be guided by rollers (not shown) to assist in the raising/lowering of the weights 106, 108.

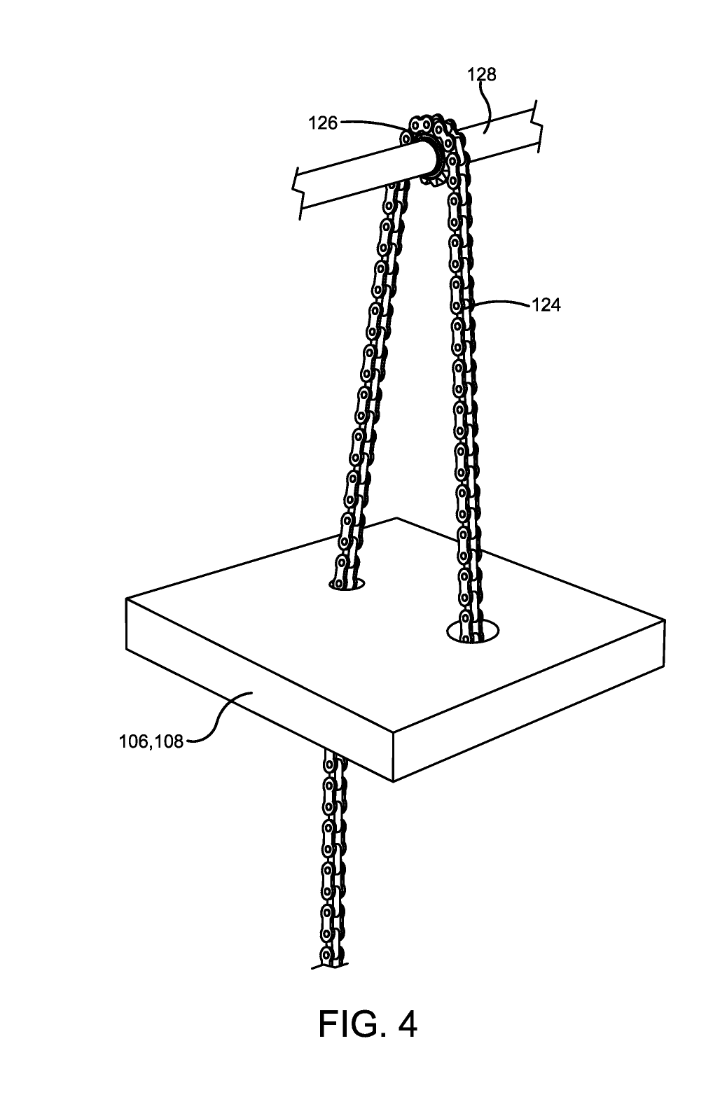

Additionally, the weights 106, 108 of the first 102 and the second 104 vertical members are each secured to a chain 124 (or other suspension device) which is passed over a sprocket 126 (or other load transferring device). The weights 106, 108 would be secured to the chain 124 via any suitable hardware, such as nuts, bolts, screws, etc. The sprockets 126 are then secured (rigidly attached) to an axle 128, such that passing the chain 124 over the sprockets 126 rotates the axles 128 (as shown in FIG. 4).

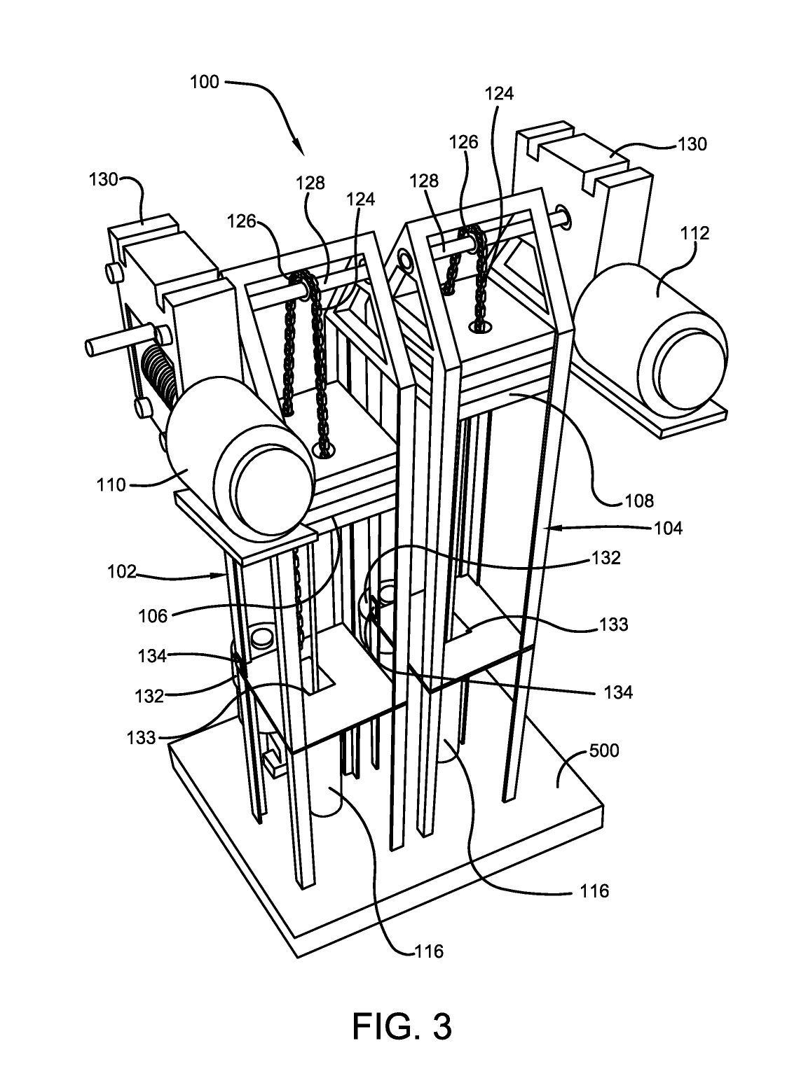

Furthermore, the energy generator device 100 comprises a gear box 130 and a magnetic induction component 110, 112. Typically, the gearbox 130 is secured to each axle 128 of the first 102 and second 104 vertical members and to the magnetic induction generation component 110, 112 (as shown in FIG. 3). The gearbox 130 controls the rate of spin of the magnetic induction generation components 110, 112. Specifically, the magnetic induction generation components 110, 112 function as typical magnetic induction generation components known in the art and comprise typical components such as a turbine (not shown) which includes a plurality of magnets in rotational orientation (or alignment). When the turbine rotates, the magnets rotate past each other to create an electrical charge. Thus, rotation of the axles 128 rotates the turbines of the magnetic induction generation components 110, 112 to produce electricity. Further, the gearbox 130 acts to control the rate of spin (or rotation) of the turbine of the magnetic induction generation component 110, 112, which, in turn, controls the amount of electricity produced by the turbine.

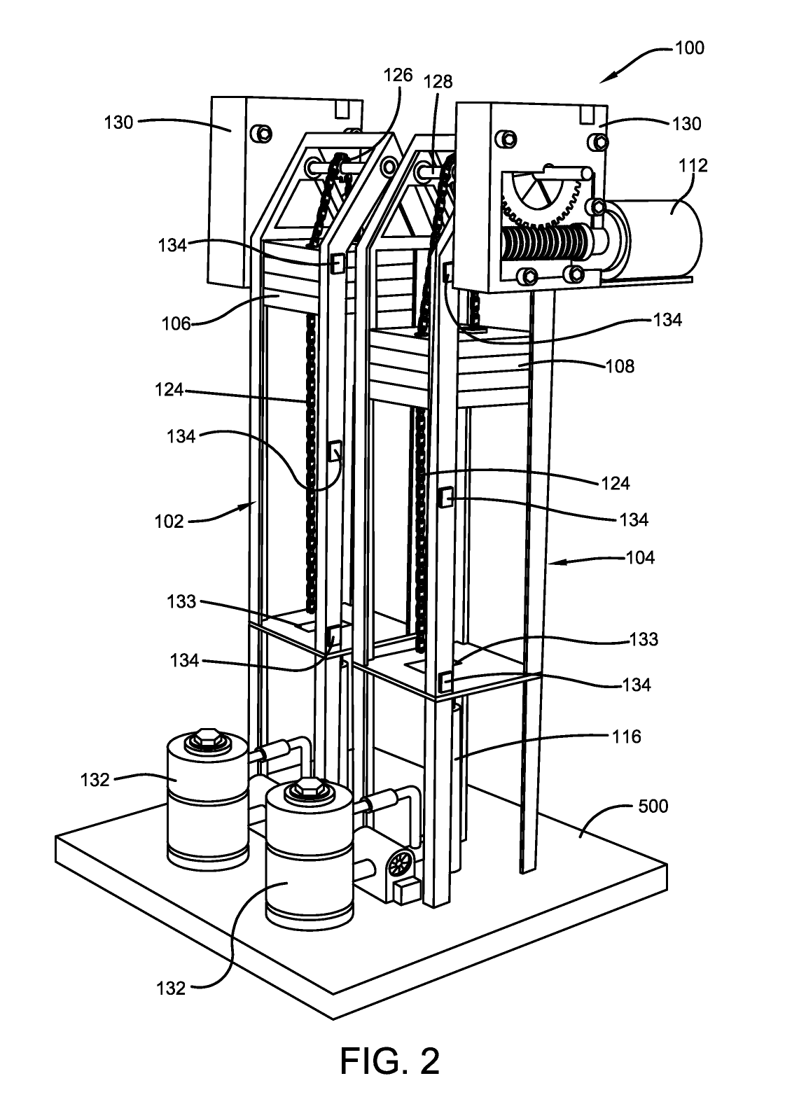

Additionally, the energy generator device 100 comprises a fluid motion device, such as a pump and valve assembly or a hydraulic pump and piston 132 which acts to raise the weights 106, 108. Specifically, a hydraulic pump and piston 132 is secured to both the first 102 and second 104 vertical members and controls the raising or elevating of the weights 106, 108 (as shown in FIG. 2). The hydraulic pump 132 for each unit is powered by the generator 110, 112 of the opposite unit during the weight 106, 108 descend. Hydraulic pumps can generate tremendous pressure/lift with very little applied electrical energy. The fluid motion device can be any suitable fluid motion device as is known in the art without affecting the overall concept of the invention. Turning on the hydraulic pump would activate the piston 132 which would raise the weights 106, 108 (i.e., the piston arms are telescopic and will protrude from the piston case). The piston will attach directly to the weight bottom, and acts not only to stabilize the weight, but also to control the velocity of weight descent via a hydraulic release valve (not shown) that is controlled electronically to satisfy the electrical output demand. Thus, higher load on the generator will require more velocity of weight descend to accommodate the higher output. Further, the hydraulic pump and piston 132 comprises a switch 134 which activates the hydraulic pump and piston 132 when the weights 106, 108 are proximate to a descent (lower) limit (or at a predetermined distance from the lower limit). The switch 134 can be any suitable switch as is known in the art, such as a laser, a pressure switch, a heat switch, a proximity switch, electric switch, ultrasonic switch, etc.

Specifically, the weights 106, 108 move opposite of each other, such that when one weight is raised the other is lowered, etc. The weights 106, 108 would be positioned such that as weight 106 is descending, it activates switch 134 which turns on the hydraulic pump 132 (which activates the hydraulic piston) of the second vertical member 104, which then acts to raise weight 108 of the second vertical member 104. Then, when weight 108 reaches its upper limit, it is released and free falls (or descends) down toward the ground. As weight 108 is descending, it activates switch 134 which turns on the hydraulic pump 132 (which activates the hydraulic piston) of the first vertical member 102, which then acts to raise weight 106 of the first vertical member 104. Then, when weight 106 reaches its upper limit, it is released and free falls (or descends) down toward the ground. Then, the process continues to repeat itself. Specifically, each unit (vertical member 102) will need a minimum of three switches 134 for controlling the hydraulics and valve system 132. The upper switch will act to disengage the electricity being applied to the pump for that particular unit and to open the piston valve to allow descend. The mid-level switch will act to engage power to the pump of the opposite unit in preparation for its descend. The lower switch will close the valve of the of the unit that has descended and open the valve of the opposite unit allowing for its descend, also activating a transfer switch to move the output power of the bottomed-out unit's generator to the second unit's generator (as this unit will have already reached its upper limit switch and opened the piston valve allowing for its descend). The raising and/or lowering of the weights 106, 108 rotates the axles 128, which in turn rotates the turbines of the magnetic induction generation components 110, 112 to produce electricity.

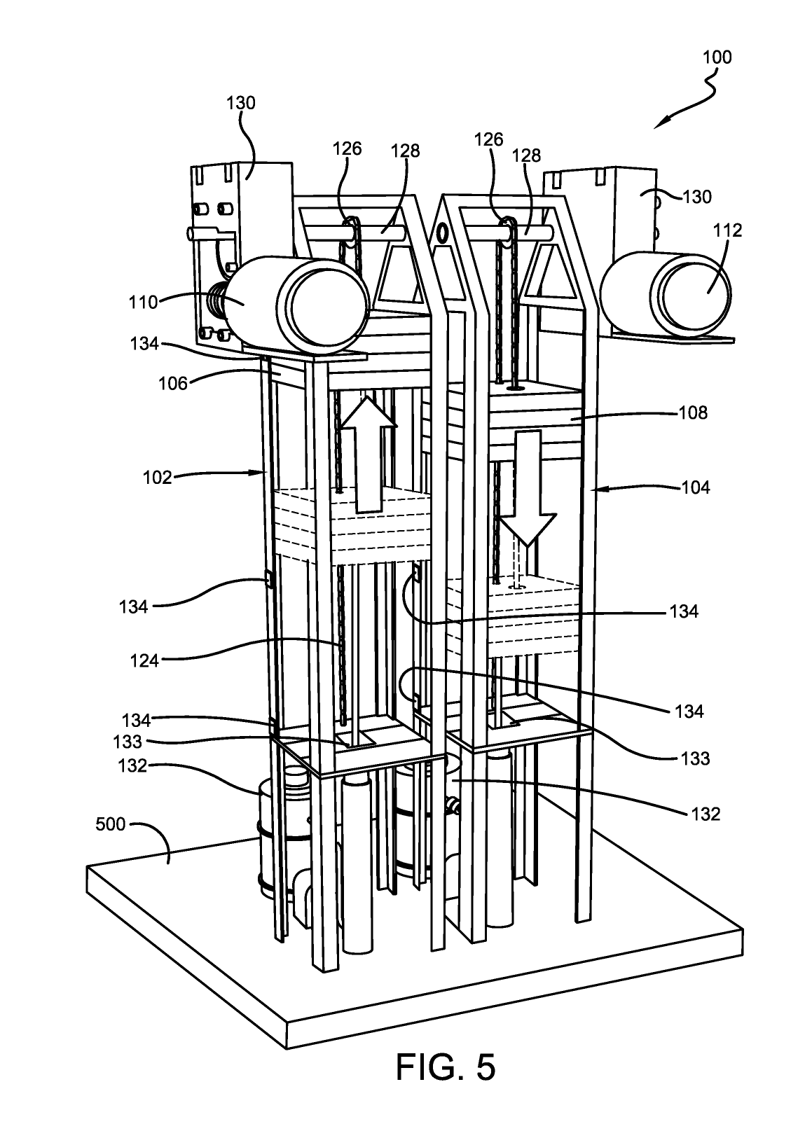

FIG. 5 illustrates the energy generator device 100 in motion. In operation, a user (not shown) would choose the size and/or shape of the energy generator device 100 that meets their needs and/or wants. The user would then determine where and in what configuration to position the energy generator device 100 in their residence and/or business. The user would then position the first 102 and the second 104 vertical members of the energy generator device 100 on a predetermined surface in a pre-determined configuration, with the vertical members 102, 104 side-by-side and secured together by the axels 128, and with the axels 128 secured to a gear box 130 and a magnetic induction generator component 110, 112.

The user would then determine how much weight 106, 108 to place on each vertical member 102, 104, making sure that each vertical member 102, 104 contains the same amount of weights 106, 108. Then, the user would fixedly attach a sprocket 126 to each axel 128 of the vertical members 102, 104, and would secure a chain 124 to each weight 106, 108. Once secure, the user would then pass the free end of the chain 124 over the sprocket 126 and axle 128 and then would secure the free end of the chain 124 to the base of the vertical members 102, 104.

The user then secures a hydraulic pump and piston 132 to the base of the vertical members 102, 104, placing the hydraulic pump and piston 132 in communication with the weights 106, 108, to control the raising or elevating of the weights 106, 108. Turning on the hydraulic pump would activate the piston 132 which would raise the weights 106, 108. Further, a switch 134 at the base of the vertical members 102, 104 activates the hydraulic pump and piston 132 when the weights 106, 108 are proximate to a lower limit (or at a predetermined distance from the lower limit).

The weights 106, 108 move opposite of each other, such that when one weight is raised the other is lowered, etc. Once the user places the weights 106, 108 in position, the energy generator device 100 is activated, causing weight 106 to descend toward the ground. As weight 106 descends, it activates switch 134 which turns on the hydraulic pump 132 (which activates the hydraulic piston) of the second vertical member 104, which then acts to raise weight 108 of the second vertical member 104. Then, when weight 108 reaches its upper limit, it is released and free falls (or descends) down toward the ground.

As weight 108 descends, it activates switch 134 which turns on the hydraulic pump 132 (which activates the hydraulic piston) of the first vertical member 102, which then acts to raise weight 106 of the first vertical member 104. Then, when weight 106 reaches its upper limit, it is released and free falls (or descends) down toward the ground. Then, the process continues to repeat itself. The raising and/or lowering of the weights 106, 108 rotates the axles 128, which in turn rotates the turbines of the magnetic induction generation components 110, 112 to produce electricity.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An energy generator device comprising:
a first vertical member comprising a first end portion, and a second end portion, and opposing sides, and at least one weight;
a second vertical member comprising a first end portion, and a second end portion, and opposing sides, and at least one weight; and
wherein the at least one weight of the first and the second vertical members move opposite of each other; and
wherein the at least one weight of the first and the second vertical members are each secured to a fluid motion device which acts to raise the at least one weight; and
a magnetic induction generation component in communication with the at least one weight, such that the raising or lowering of the at least one weight causes the magnetic induction generation component to rotate and produce electricity.

2. The energy generator device of claim 1, wherein the at least one weight of the first and the second vertical members are each secured to a chain which is passed over a sprocket.

3. The energy generator device of claim 2, wherein each of the sprockets are secured to an axle, and passing the chain over the sprockets rotates the axles, which in turn rotates the magnetic induction generation component.

4. The energy generator device of claim 3, further comprising a gearbox secured to each axle and to the magnetic induction generation component, for controlling rate of spin of the magnetic induction generation component.

5. The energy generator device of claim 1, wherein the fluid motion device is a pump and valve assembly.

6. The energy generator device of claim 1, wherein the fluid motion device is a hydraulic piston.

7. The energy generator device of claim 6, further comprising a switch that activates the hydraulic piston when the at least one weight is proximate to a lower limit.

8. The energy generator device of claim 1, wherein the at least one weight of the first and the second vertical members are guided by rollers.

9. An energy generator device comprising:
a first vertical member comprising a first end portion, and a second end portion, and opposing sides, and at least one weight;
a second vertical member comprising a first end portion, and a second end portion, and opposing sides, and at least one weight; and
wherein the at least one weight of the first and the second vertical members are each secured to a chain which is passed over a sprocket which is secured to an axle, such that the at least one weight of the first and the second vertical members move opposite of each other; and
wherein the at least one weight of the first and the second vertical members are each secured to a fluid motion device which acts to raise the at least one weight; and
a magnetic induction generation component in communication with the at least one weight, such that the raising or lowering of the at least one weight causes the chain to pass over the sprockets, which rotates the axles which in turn causes the magnetic induction generation component to rotate and produce electricity.

10. The energy generator device of claim 9, further comprising a gearbox secured to each axle and to the magnetic induction generation component, for controlling rate of spin of the magnetic induction generation component.

11. The energy generator device of claim 9, wherein the fluid motion device is a pump and valve assembly.

12. The energy generator device of claim 9, wherein the fluid motion device is a hydraulic piston.

13. The energy generator device of claim 12, further comprising a switch that activates the hydraulic piston when the at least one weight is proximate to a lower limit.

14. The energy generator device of claim 9, wherein the at least one weight of the first and the second vertical members are guided by rollers.

15. An energy generator device comprising:
a first vertical member comprising a first end portion, and a second end portion, and opposing sides, and at least one weight;
a second vertical member comprising a first end portion, and a second end portion, and opposing sides, and at least one weight; and
wherein the at least one weight of the first and the second vertical members move opposite of each other; and
wherein the at least one weight of the first and the second vertical members are each secured to a hydraulic piston device which acts to raise the at least one weight; and
a magnetic induction generation component in communication with the at least one weight, such that the raising or lowering of the at least one weight causes a turbine within the magnetic induction generation component to rotate and produce electricity.

16. The energy generator device of claim 15, wherein the at least one weights of the first and the second vertical members are guided by rollers.

17. The energy generator device of claim 15, wherein the at least one weight of the first and the second vertical members are each secured to a chain which is passed over a sprocket.

18. The energy generator device of claim 17, wherein each of the sprockets are secured to an axle, and passing the chain over the sprockets rotates the axles, which in turn rotates the turbine of the magnetic induction generation component.

19. The energy generator device of claim 18, further comprising a gearbox secured to each axle and to the magnetic induction generation component, for controlling rate of spin of the turbine of the magnetic induction generation component.

20. The energy generator device of claim 15, further comprising a switch that activates the hydraulic piston when the at least one weight is proximate to a lower limit.
